(19) United States
(12) Patent Application Publication
(10) Pub. No.: US 2017/0043217 A1
(43) Pub. Date: Feb. 16, 2017

(54) ELECTRONIC DEVICE PROVIDING EXERCISE GUIDE AND METHOD OF OPERATING THE ELECTRONIC DEVICE

(71) Applicant: Samsung Electronics Co., Ltd., Gyeonggi-do (KR)

(72) Inventor: Sanghwa LEE, Seoul (KR)

(73) Assignee: Samsung Electronics Co., Ltd.

(21) Appl. No.: 15/187,334

(22) Filed: Jun. 20, 2016

(30) Foreign Application Priority Data
Aug. 11, 2015 (KR) 10-2015-0113094

(51) Int. Cl. A63B 24/00; G06F 3/0481; A63B 71/06

(52) U.S. Cl. CPC A63B 24/0075; A63B 24/0062; A63B 71/0686; G06F 3/0481; A63B 2071/0655

(57) ABSTRACT

A method and an electronic device for providing an exercise guide is provided. The method includes determining an output period, outputting a guide signal based on the output period, updating the output period of the guide signal based on a motion of a user, and outputting the guide signal based on the updated output period.

### PRIORITY

This application claims priority under 35 U.S.C. §119(a) to Korean Patent Application Serial No. 10-2015-0113094, which was filed in the Korean Intellectual Property Office on Aug. 11, 2015, the entire content of which is incorporated herein by reference.

### BACKGROUND

1. Field of the Disclosure

The present disclosure generally relates to an electronic device, and more particularly, to providing an exercise guide and a method of operating the electronic device.

2. Description of the Related Art

A wearable device, such as a smart watch and smart glasses, may transmit and receive various pieces of information to and from an electronic device in real time. A movement or stop, an exercise state, a health state, and the like, may be identified by installing various sensors in such a wearable device.

Recently, users enjoying exercise such as health, yoga, running and outdoor sports are increasing. Therefore, the users may identify an exercise state, a health state, and the like, in real time by wearing a wearable device that is easier to carry than the electronic device.

The above-mentioned electronic device only outputs a message and the like to enable a user to control the strength of an exercise using the current heartbeat rate of the user, but has difficulty in providing an exercise guide to the user based on an exercise target of the user, and the like.

### SUMMARY

Various embodiments of the present disclosure for resolving such existing problems sense a motion of a user and provide an exercise guide to the user based on the motion, an exercise target of the user, and the like.

According to an aspect of the present disclosure, an operation method for providing an exercise guide includes determining an output period, outputting a guide signal based on the output period, updating the output period of the guide signal based on a motion, and outputting the guide signal based on the updated output period.

According to an aspect of the present disclosure, an electronic device for providing an exercise guide includes a control unit configured to determine an output period, to output a guide signal based on the output period, to update the output period of the guide signal based on a motion, and to output the guide signal based on the updated output period, and a display unit configured to output the guide signal based on the output period by a control of the control unit.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a block diagram of an electronic device, according to an embodiment of the present disclosure;

FIG. 2 is a flowchart describing a method for providing an exercise guide, according to an embodiment of the present disclosure;

FIG. 3 is a flowchart describing a method of determining an exercise guide, according to an embodiment of the present disclosure;

FIG. 4 is a screen shot illustrating determining an exercise guide in the case of dynamic exercise, according to an embodiment of the present disclosure;

FIG. 5 is a screen shot illustrating determining an exercise guide in the case of dynamic exercise, according to another embodiment of the present disclosure;

FIG. 6 is a screen shot illustrating determining an exercise guide in the case of static exercise, according to an embodiment of the present disclosure;

FIG. 7 is a flowchart describing a method of outputting an exercise guide, according to an embodiment of the present disclosure;

FIG. 8 is a screen shot illustrating the case of dynamic exercise, according to an embodiment of the present disclosure;

FIG. 9 is a screen shot illustrating the case of a rest in the middle of dynamic exercise, according to an embodiment of the present disclosure;

FIG. 10A is a screen shot illustrating the case of dynamic exercise, according to another embodiment of the present disclosure;

FIG. 10B is a screen shot illustrating the case of a dynamic exercise, according to another embodiment of the present disclosure;

FIG. 11 is a screen shot illustrating the case of the dynamic exercise in another device, according to another embodiment of the present disclosure;

FIG. 12 is a screen shot illustrating the case of dynamic exercise in another device, according to another embodiment of the present disclosure;

FIG. 13 is a flowchart describing a method of outputting the exercise guide, according to another embodiment of the present disclosure;

FIG. 14 is a screen shot illustrating the case of static exercise, according to another embodiment of the present disclosure;

FIG. 15 is a screen shot illustrating an exercise result screen, according to an embodiment of the present disclosure; and

FIG. 16 is a screen shot illustrating an exercise result screen, according to another embodiment of the present disclosure.

### DETAILED DESCRIPTION

Hereinafter, various embodiments of the present disclosure will be described with reference to the accompanying drawings. The embodiments and terms used herein do not limit the technology disclosed herein to specific forms, and should be understood to include various modifications, equivalents, and/or alternatives to the corresponding embodiments. In describing the drawings, similar reference numerals may be used to designate similar constituent elements. As used herein, singular forms may include plural forms as well, unless the context clearly indicates otherwise.

As described above, an electronic device for providing an exercise guide and an operation method of the electronic device according to an embodiment of the present disclosure, senses a motion of a user, and provides an exercise guide to the user based on the motion, an exercise target of the user and the like. Therefore, the electronic device for providing the exercise guide and the operation method of the electronic device according to an embodiment of the present disclosure, may enable the user to exercise in accordance with a current state and the exercise target, and thus the efficiency of the electronic device and the convenience for the user may be improved.

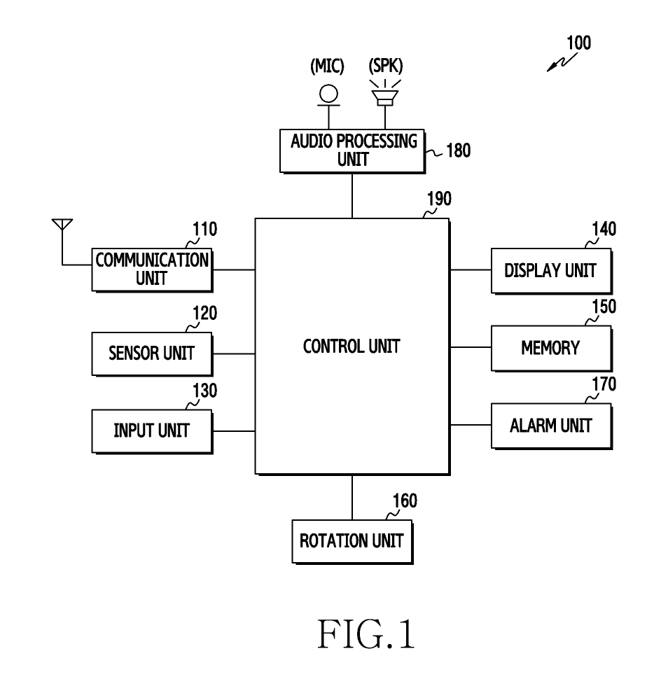

FIG. 1 is a block diagram of an electronic device, according to an embodiment of the present disclosure.

Referring to FIG. 1, the electronic device 100 according to an embodiment of the present disclosure includes a communication unit 110, a sensor unit 120, an input unit 130, a display unit 140, a memory 150 and a control unit 190. The electronic device 100 may be a wearable device including a smart watch and smart glasses.

The communication unit 110 may perform communication with at least one external device including a portable electronic device such as a smart phone and a tablet PC, and an electronic device such as a notebook computer. The communication unit 110 may communicate with the external device in various communication methods. The communication unit 110 may perform at least one of wireless communication and wired communication. The communication unit 110 may be connected to at least one of a mobile communication network and a data communication network. The communication unit 110 may perform short range wireless communication such as Bluetooth and near field communication (NFC). The communication unit 110 may perform communication with a global positioning system (GPS) in order to identify a position of the electronic device 100.

The sensor unit 120 may sense a movement state (e.g., a movement or stop, a movement speed, and the like) of the electronic device 100, a motion or stop based on the movement of the user having the electronic device 100, a motion number based on the movement of the user having the electronic device 100, and the like. The sensor unit 120 may include a gyro sensor, an acceleration sensor, and a geomagnetic field sensor. The sensor unit 120 may include a heartbeat measuring sensor for measuring a heartbeat of a user.

The input unit 130 may generate input data corresponding to a user input of the electronic device 100. The input unit 130 may include at least one input means. The input unit 130 may include a key pad, a dome switch, a button, a touch panel, a jog & shuttle, and a sensor.

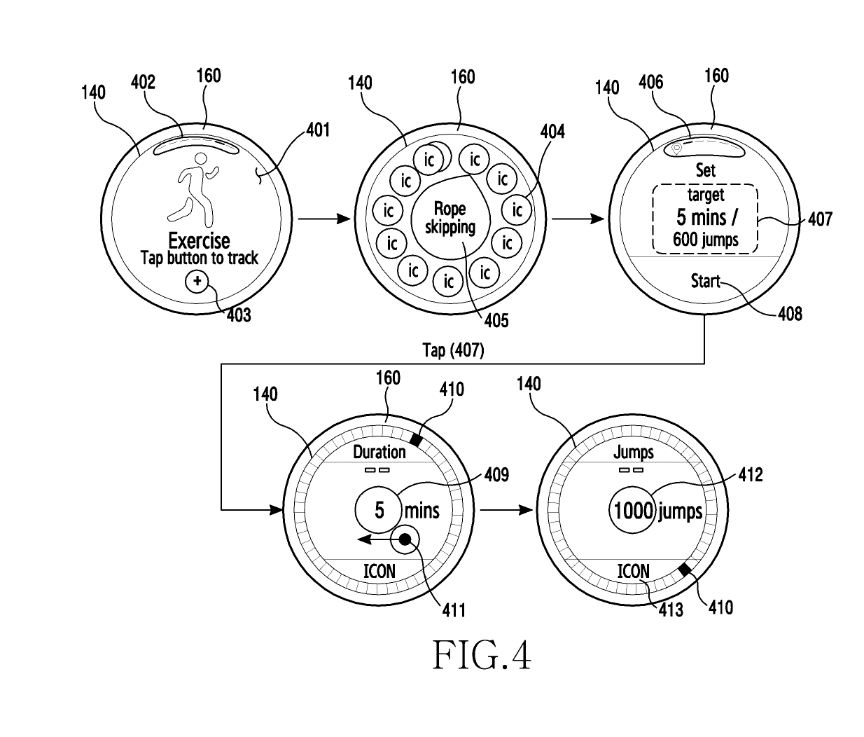

The display unit 140 may display a screen according to an operation of the electronic device 100. The display unit 140 may include a liquid crystal display (LCD), a light emitting diode (LED) display, an organic LED (OLED) display, a microelectromechanical system (MEMS) display, and an electronic paper display. The display unit 140 may be combined with the input unit 130 and thus may be implemented as a touch screen. The display unit 140 may be implemented in various types. In the present disclosure, the display unit 140 may be implemented in a circular shape as shown in FIG. 4.

The memory 150 may store operation programs of the electronic device 100. The memory 150 may store an application for providing an exercise guide, and may store profile information of a user. The memory 150 may store an exercise target or a target exercise strength of the user, and an exercise result according to the exercise target or target exercise strength of the user.

A rotation unit 160 generates rotation input data in the electronic device 100. The rotation unit 160 may generate the rotation input data corresponding to the user input of the electronic device 100. The rotation unit 160 is combined with an edge of the display unit 140 such that the rotation unit 160 may be rotated. The rotation unit 160 may be implemented in various types. The rotation unit 160 may be implemented in a ring type as shown in FIG. 4. For example, the rotation unit 160 may be implemented in a ring type of a circuit type. That is, the rotation unit 160 may be implemented to surround the display unit 140. The rotation unit 160 may be rotated in a clockwise direction or a counterclockwise direction based on a center axis of the display unit 140. The rotation unit 160 may be implemented in a cylinder type. For example, the rotation unit 160 may be implemented in a type such as a crown of an analog clock. That is, at least some of the rotation unit 160 may be inserted into the inside of the electronic device 100, and the remaining portions of the rotation unit 160 may protrude to the outside of the electronic device 100. The rotation unit 160 may be rotated in a clockwise direction or a counterclockwise direction based on a vertical axis that is perpendicular to the center axis of the display unit 140. In addition, the rotation unit 160 may generate squeezing (or pressing) input data. The rotation unit 160 may generate the squeezing (or pressing) input data corresponding to the user input of the electronic device 100.

An alarm unit 170 may process a vibration signal. The alarm unit 170 may be a vibration motor. The alarm unit 170 may be operated according to the control of the control unit 190, and may output a guide signal based on an exercise guide.

The audio processing unit 180 may process an audio signal. The audio processing unit 180 may include a speaker (SPK) and a microphone (MIC). The audio processing unit 180 may reproduce the audio signal output from the control unit 190 through the speaker. The audio processing unit 180 may transfer the audio signal generated from the microphone to the control unit 190. The speaker of the audio processing unit 180 may output the guide signal based on the exercise guide under the control of the control unit 190.

The control unit 190 may provide the exercise guide to a user. The control unit 190 may determine an output period for outputting the guide signal based on the exercise guide, and may output the guide signal based on the determined output period. The control unit 190 may update the output period of the guide signal based on a motion of the user sensed by the sensor unit 120, and may output the guide signal based on the updated output period. The control unit 190 may output the guide signal in at least one of a vibration through the alarm unit 170, a sound through the speaker, and an image through the display unit 140.

According to an embodiment of the present disclosure, an electronic device providing an exercise guide may include a control unit 190 configured to determine an output period, to output a guide signal based on the output period, to update the output period of the guide signal based on a motion, and to output the guide signal based on the updated output period, and a display unit 140 configured to output the guide signal based on the output period by control of the control unit 190. The electronic device may include an alarm unit 170 outputting the guide signal as a vibration.

The control unit 190 may set a target exercise time and a target motion number, and may determine the output period based on the target exercise time and the target motion number. The control unit 190 may accumulate exercise data based on a motion number sensed during a predetermined time, and may update the output period based on a remaining time obtained by subtracting the predetermined time from the target exercise time, and a remaining motion number obtained by subtracting the sensed motion number from the target motion number.

The control unit 190 may sense a motion number during a predetermined time, and may output a guide signal indicating a rest state when the motion is not sensed during a critical time. The control unit 190 may update the target exercise time by adding the critical time to the target exercise time when the motion is sensed again, and may update the output period based on the updated target exercise time, and a remaining motion number obtained by subtracting the sensed motion number from the target motion number.

The control unit 190 may determine the output period according to a predetermined condition. The control unit 190 may calculate an average time of the motion based on a motion number sensed during a predetermined time, and may update the output period using the average time.

The control unit 190 may set target exercise strength, and may determine the output period based on the target exercise strength. The control unit 190 may calculate an average time of the motion based on a motion number sensed during a predetermined time, and may update the output period based on the average time in a time range set according to the target exercise strength.

The control unit 190 may output the guide signal based on the output period when the motion is stopped.

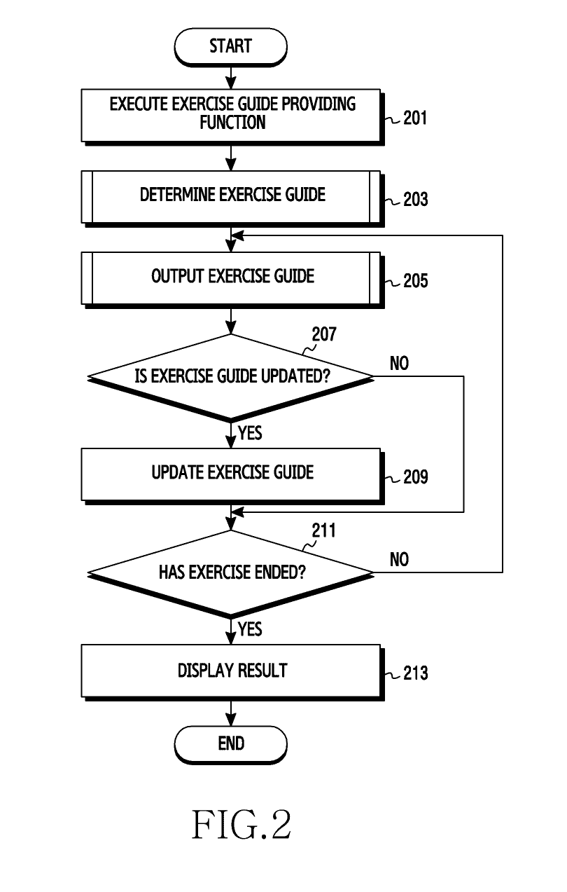

FIG. 2 is a flowchart describing a method for providing an exercise guide, according to an embodiment of the present disclosure.

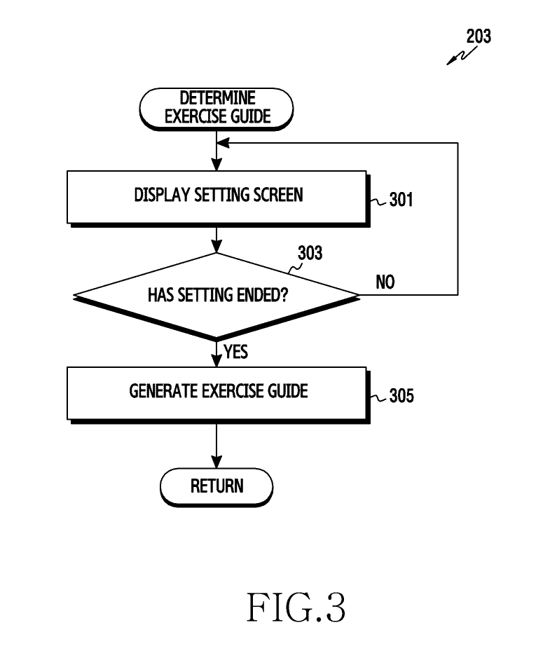

Referring to FIG. 2, in step 201, the control unit 190 executes an exercise guide providing function. The exercise guide providing function may be an application. In step 203, the control unit 190 determines an exercise guide. The control unit 190 may determine an exercise guide for at least one exercise of a dynamic exercise and a static exercise. The dynamic exercise may include a jump rope, walking and running, and the static exercise may be an exercise in which the user's breath is important in the case of the exercise, such as yoga and a breathing exercise. An operation for determining the exercise guide is described in more detail with reference to FIGS. 3 to 6.

In step 205, the control unit 190 outputs the exercise guide determined in step 203. When providing the exercise guide for the dynamic exercise is determined in step 203, the control unit 190 may output the guide signal in accordance with a time when a user should move dynamically based on the exercise guide for the dynamic exercise, in step 205.

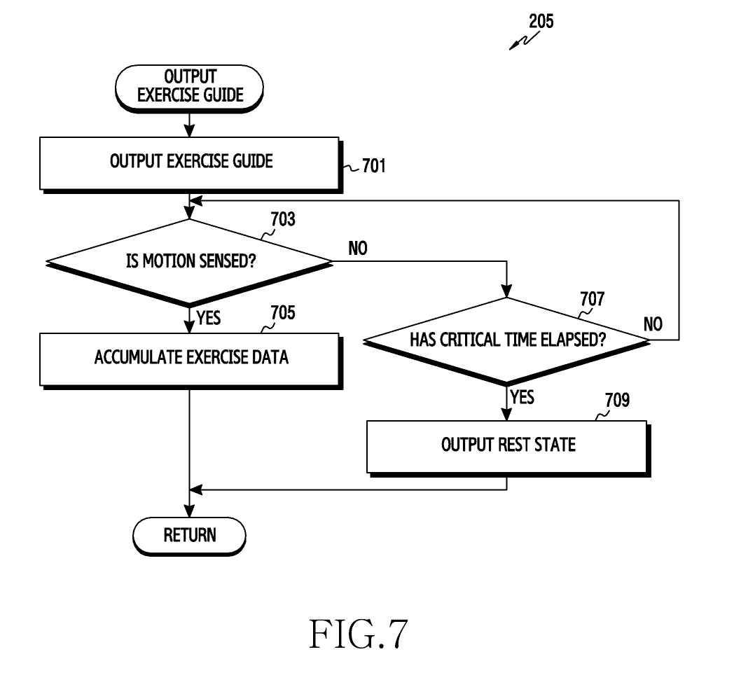

When providing the exercise guide for the static exercise is determined in step 203, the control unit 190 may output the guide signal in accordance with a time when a user should breathe in the case of the exercise based on the exercise guide for the static exercise, in step 205. An operation for outputting the guide signal is described in more detail with reference to FIGS. 7 to 14.

In step 207, the control unit 190 checks whether the exercise guide is updated. As a result of the check of step 207, when updating the exercise guide is necessary, the control unit 190 may perform step 209. The control unit 190 may accumulate exercise data during a predetermined time based on a motion of the user that is sensed through the sensor unit 120. The control unit 190 may compare the accumulated exercise data with the exercise guide. According to the compared result, the control unit 190 may check whether the exercise guide is updated.

In step 209, the control unit 190 updates the exercise guide. In step 211, when an exercise end is sensed, the control unit 190 performs step 213. In step 211, when the exercise end is not sensed, the control unit 190 returns to step 205. The control unit 190 may perform the above-mentioned operations again based on the updated exercise guide.

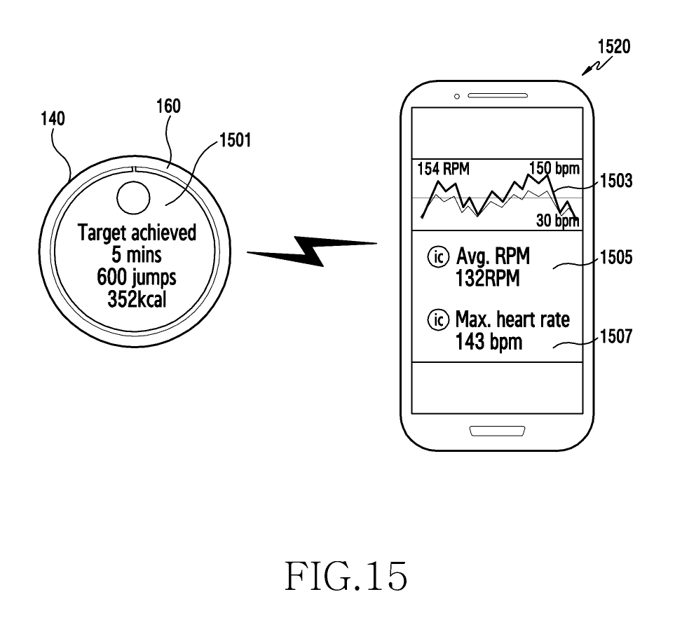

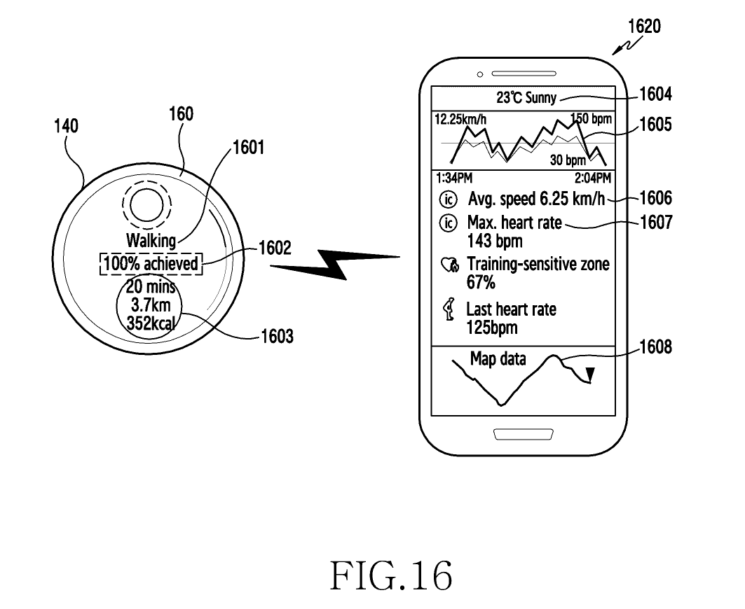

In step 213, the control unit 190 displays an exercise result on the display unit 140. An operation for displaying the exercise result is described in more detail with reference to FIGS. 15 and 16.

FIG. 3 is a flowchart describing a method of determining an exercise guide, according to an embodiment of the present disclosure.

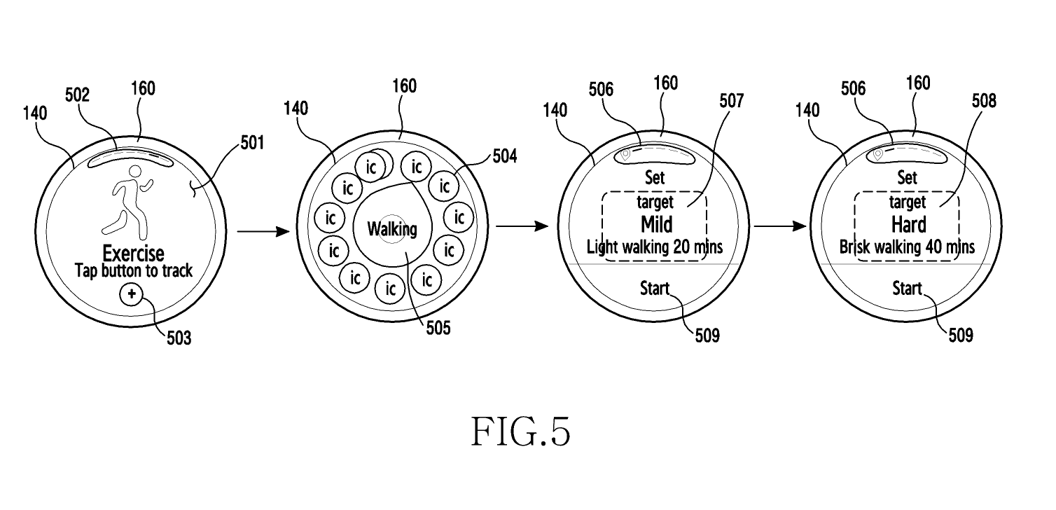

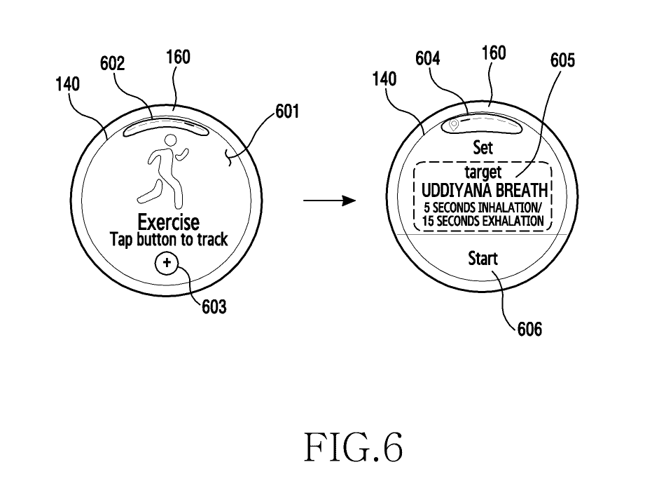

Referring to FIG. 3, in step 301, the control unit 190 displays a setting screen for determining the exercise guide on the display unit 140. The control unit 190 selects the dynamic exercise and the static exercise in the setting screen. The control unit 190 selects the type of dynamic exercise in the case of the dynamic exercise selection. The control unit 190 may set at least one of an exercise target, an exercise strength, and profile information of the dynamic exercise. An operation for determining the exercise guide for the dynamic exercise is described in more detail with reference to FIGS. 4 and 5. The control unit 190 may set breathing information and the like in the case of the static exercise selection. An operation for determining the exercise guide for the static exercise is described in more detail with reference to FIG. 6.

In step 303, if the setting for determining the exercise guide is finished, the control unit 190 performs step 305. In step 303, if the setting for determining the exercise guide is not finished, the control unit 190 returns to step 301. In step 305, the control unit 190 generates the exercise guide using the set information.

FIG. 4 is a screen shot illustrating determining an exercise guide in the case of a dynamic exercise, according to an embodiment of the present disclosure. FIG. 4 is related to an embodiment in which the exercise target is set as the dynamic exercise.

Referring to FIG. 4, the control unit 190 may execute an application, and displays an execution screen 401 on the display unit 140. The control unit 190 may execute a function selected by an indicator 402 displayed on the execution screen 401 by the rotation of the rotation unit 160. In addition, when an exercise addition menu 403 displayed on the execution screen 401 is selected, the control unit 190 may display a screen for selecting an exercise type.

When an icon for a jump rope is selected by the input unit 130 or the rotation of the rotation unit 160 on the screen in which a plurality of icons 404 for the exercise type is displayed, the control unit 190 may select the jump rope. The control unit 190 may display the selection of the jump rope 405 on the display unit 140. When the jump rope 405 is selected, the control unit 190 may display a screen for setting the exercise target, which is a target exercise time and a target motion number. The control unit 190 may display an exercise target 407 set in the jump rope on the display unit 140. The control unit 190 may set an exercise target in which the target exercise time and the target motion number are set together, by using an indicator 406 of the rotation unit 160. The exercise target changed by the indicator 406 may be an exercise result stored in the memory 150.

When the set exercise target 407 is selected, the control unit 190 may set a target exercise time 409. The control unit 190 may set the target exercise time by the rotation of the rotation unit 160 or the input of the input unit 130. The control unit 190 may display 410 the set target exercise time on an edge of the display unit 140. The control unit 190 may change the screen for setting the target exercise number when a drag signal is generated in an arrow direction at a specific position 411 of the display unit 140 by the input unit 130.

The control unit 190 may set the target exercise number 412. The control unit 190 may set the target exercise number by the rotation of the rotation unit 160 or the input of the input unit 130. The control unit 190 may display 410 the set target exercise number on the edge of the display unit 140. When an icon menu 413 is selected by the input unit 130, the control unit 190 may set the target exercise time and the target motion number as the exercise target, and may display the target exercise time and the target motion number on the display unit 140. When a start menu 408 is selected in a screen displaying the exercise target 407, the control unit 190 may generate the exercise guide. When an exercise target in which jumping rope 600 times is performed for five minutes is set, the control unit 190 may generate an exercise guide such that a guide signal may be output every 0.5 second.

FIG. 5 is a screen shot illustrating determining an exercise guide in the case of a dynamic exercise, according to another embodiment of the present disclosure. FIG. 5 is related to an embodiment in which at least one of the exercise strength and the profile information is set in the dynamic exercise.

Referring to FIG. 5, the control unit 190 may execute an application, and may display an execution screen 501 on the display unit 140. The control unit 190 may execute a function selected by an indicator 502 displayed on the execution screen 501 by the rotation of the rotation unit 160. In addition, when an exercise addition menu 503 displayed on the execution screen 501 is selected, the control unit 190 may display a screen for selecting an exercise type.

When an icon for walking is selected by the input unit 130 or the rotation of the rotation unit 160 on the screen in which a plurality of icons 504 for the exercise type is displayed, the control unit 190 may select walking based on a user input. The control unit 190 may display the selection of walking 505 on the display unit 140. When walking 505 is selected, the control unit 190 may display a screen for setting the target exercise strength. The control unit 190 may display a target exercise strength “Mild” 507, which is set in walking, on the display unit 140. The control unit 190 may set the exercise strength as “Hard” 508 by the rotation of the rotation unit 160. The target exercise strength that is changed by the indicator 506 may be an exercise result stored in the memory 150. The control unit 190 may set the exercise strength by the input of the input unit 130. The exercise strength of “Mild” may be lower than the exercise strength of “Hard”. When a start menu 509 is selected on the screen displaying the target exercise strength 507 or 508, the control unit 190 may generate the exercise guide.

The control unit 190 displays the selection of walking 505 on the display unit 140, and when the target exercise strength is not set, the control unit 190 may check whether the profile is included in the memory 150. When a profile (e.g., age, and sex information) of a user is included in the memory 150, the control unit 190 may retrieve the information stored in the memory 150. The control unit 190 may retrieve average information, such as an average step of people of a sex or an age group which is the same as a sex or an age group of the user stored in the memory 150, and an average time when a motion (e.g., an action taking a step on the ground forward is sensed as one motion) is sensed, based on the profile.

The control unit 190 may set the guide signal output period as the retrieved average time to generate the exercise guide capable of outputting the guide signal every period of the average time. For example, if an average time when a motion of a 30 year woman is sensed is 1 second, the control unit 190 may generate an exercise guide capable of outputting the guide signal every 1 second. When there is no profile, the control unit 190 may generate average information using an input profile.

The control unit 190 may generate the exercise guide based on at least one of the target exercise strength and the profile information. For example, the control unit 190 may retrieve the average step and the average time of the user, which are stored in the memory 150 based on the profile information, and may set the output period of the guide signal based on the set target exercise strength. The average time stored in the memory 150 may be an average time when the exercise strength is “Mild”. Therefore, when the target exercise strength is “Hard”, the control unit 190 may set the guide signal output period as a time that is faster than the average time. Regarding each of target exercise strengths, a range of the average time may be set in the target strength. For example, in “Mild”, the range of the average time may be set as 8 to 12 seconds per 10 steps, and in “Hard”, the range of the average time may be set as 4 to 7 seconds per 10 steps. Therefore, when the target exercise strength is “Mild”, the control unit 190 may generate the exercise guide to output the guide signal based on 10 seconds per 10 steps, which is every 1 second. When the target exercise strength is “Hard”, the control unit 190 may generate the exercise guide to output the guide signal based on 5.5 seconds per 10 steps, which is every 0.55 second.

FIG. 6 is a screen shot illustrating determining an exercise guide in the case of a static exercise, according to an embodiment of the present disclosure. FIG. 6 is related to an embodiment in which the breath guide is set in the static exercise.

Referring to FIG. 6, the control unit 190 may execute an application, and may display an execution screen 601 on the display unit 140. The control unit 190 may execute a function selected by an indicator 602 displayed on the execution screen 601 by the rotation of the rotation unit 160. In addition, when an exercise addition menu 603 displayed on the execution screen 601 is selected, the control unit 190 may display a screen for selecting an exercise type. This is described with reference to FIGS. 4 and 5, and thus detailed descriptions are omitted.

The control unit 190 may display on the display unit 140 that the selected exercise is Uddiyana breath, during yoga exercise. The control unit 190 may set the time of inhalation and exhalation by the rotation of the rotation unit 160 or the input of the input unit 130. The control unit 190 may generate an exercise guide when a start menu 606 is selected in the screen in which the inhalation and exhalation times are set. The control unit 190 may generate an exercise guide in order to output a guide signal in accordance with an inhalation of 5 seconds and an exhalation of 15 seconds as shown in screen 605.

FIG. 7 is a flowchart describing a method of outputting an exercise guide, according to an embodiment of the present disclosure. FIG. 7 describes a method of outputting an exercise guide for a dynamic exercise.

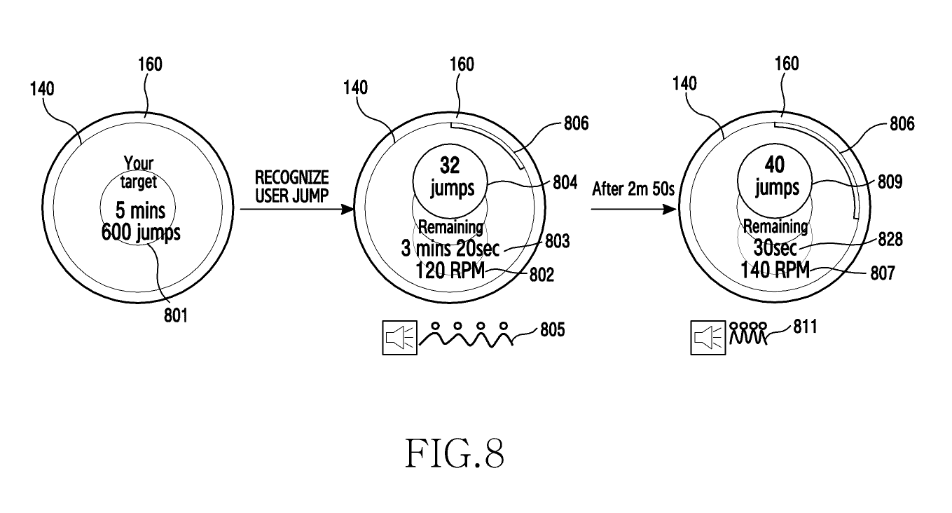

Referring to FIG. 7, in step 701, the control unit 190 outputs a generated exercise guide. In step 703, when the control unit 190 senses a motion of a user, in step 705, the control unit 190 accumulates exercise data based on a motion number sensed during a predetermined time. In step 705, the control unit 190 accumulating the exercise data performs step 207 of FIG. 2. An operation for outputting the exercise guide is described in more detail with reference to FIGS. 8, 10 and 12.

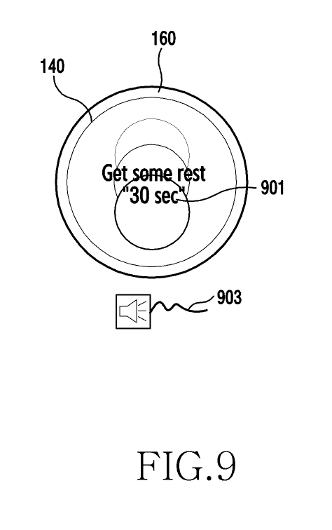

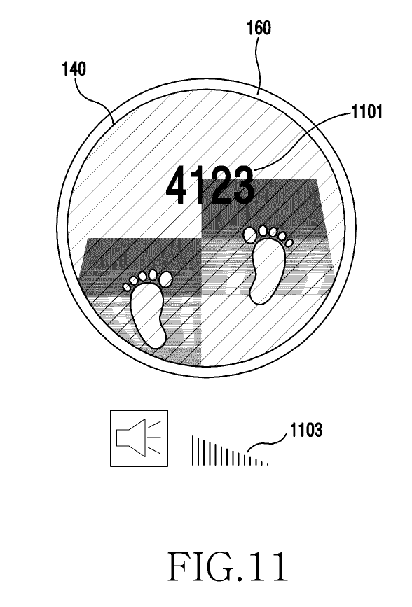

In step 703, when the control unit 190 does not sense the motion of the user by the sensor unit 120, the control unit 190 performs step 707. In step 707, when the motion of the user is not sensed and a critical time has not elapsed (e.g., 10 seconds), the control unit 190 performs step 709. In step 707, when the time when the motion of the user is not sensed and does not exceed the critical time, the control unit 190 returns to step 703. In step 709, the control unit 190 may output a guide signal indicating a rest state. An operation for outputting the guide signal indicating the rest state is described in more detail with reference to FIGS. 9 and 11.

FIG. 8 is a screen shot illustrating the case of a dynamic exercise, according to an embodiment of the present disclosure. FIG. 9 is a screen shot diagram illustrating the case of a rest in the middle of the dynamic exercise, according to an embodiment of the present disclosure.

Referring to FIGS. 7 to 9, according to an embodiment of the present disclosure, in which a user jumps rope, the control unit 190 may identify that an exercise guide for a jump rope is determined and an exercise target is set as 600 times for 5 minutes as shown in FIG. 4.

When the start menu 408 is selected in the state in which the jump rope is set as 600 times for 5 minutes as shown in FIG. 4, the control unit 190 displays an exercise target 801 on the display unit 140. The control unit 190 may identify that the motion of the user is sensed. The control unit 190 may calculate that the speed per minute of the jump rope is 120 RPM from the exercise target, and displays the calculated RPM 802 on part of the display unit 140. The control unit 190 may output a guide signal every 0.5 second based on the generated exercise guide. The control unit 190 may output the guide signal every 0.5 second in at least one of an image 804, a vibration, and a sound 805. The control unit 190 may shift the image 804 to the top and bottom direction or the left and right direction to display the image 804, in accordance with an output period of the guide signal.

The control unit 190 may calculate the remaining time by subtracting a predetermined time when the motion is sensed from the target exercise time from an exercise target 801, and may display the calculated remaining time on some of the display unit 140. The control unit 190 may display a motion number 804 whenever the motion is sensed from the time when the motion is sensed. The control unit 190 may display a predetermined elapsed time based on the target exercise time on an edge of the display unit 140 as a color 806. The control unit 190 may accumulate a motion number as the exercise data for a predetermined time, and may compare the exercise data with the exercise target. As a result of the comparison, when the control unit 190 identifies that the exercise guide set in FIG. 4 should be updated, the control unit 190 may update the exercise guide.

The control unit 190 may update the output period of the guide signal based on the remaining time obtained by subtracting the predetermined time from the target exercise time, and the remaining motion number obtained by subtracting the motion number sensed during the predetermined time from the target motion number. The control unit 190 may display the updating result on the display unit 140. The control unit 190 may display an updated RPM 807 on the display unit 140, and may display a motion number 809 sensed after the updating. The control unit 190 may display the remaining time 808 until the target exercise time. Since an output period of the updated guide signal is faster than a previous output period, the control unit 190 may output the guide signal marked as reference numeral 811 in a speed that is faster than that of the guide signal marked as reference numeral 805.

When the motion is not sensed during a critical time in the middle of the jump rope, the control unit 190 may sense that the user is in a rest state. The control unit 190 may display an image 901 indicating a rest state on the display unit 140 as shown in FIG. 9. The control unit 190 may output a guide signal in a vibration or sound for 30 seconds as shown in reference number 903, such that the user takes a rest for 30 seconds. The control unit 190 may gradually reduce the output strength of the guide signal, and may not output the guide signal for some time.

When the motion is sensed again after the rest state, the control unit 190 may update the target exercise time by adding the critical time and the rest time to the target exercise time. For example, the control unit 190 may identify that the motion is maintained for one minute and 40 seconds as shown in FIG. 8, and the motion is not sensed for the critical time (e.g., 10 seconds). Since the motion is not sensed for the critical time, the control unit 190 may provide a rest time (e.g., 30 seconds) to the user as shown in FIG. 9. Thus, since the control unit 190 subtracts 40 seconds from 3 minutes and 20 seconds, which the remaining time, the control unit 190 may add the time equal to the critical time and the rest time to the remaining time. The control unit 190 may update the output period based on the added remaining time and the remaining motion number. The control unit 190 may not limit the rest time to 30 seconds, and may sense the rest time as time until the motion of the user is sensed again. In this case, the control unit 190 may add the remaining time by adding the critical time to the actual sensed rest time.

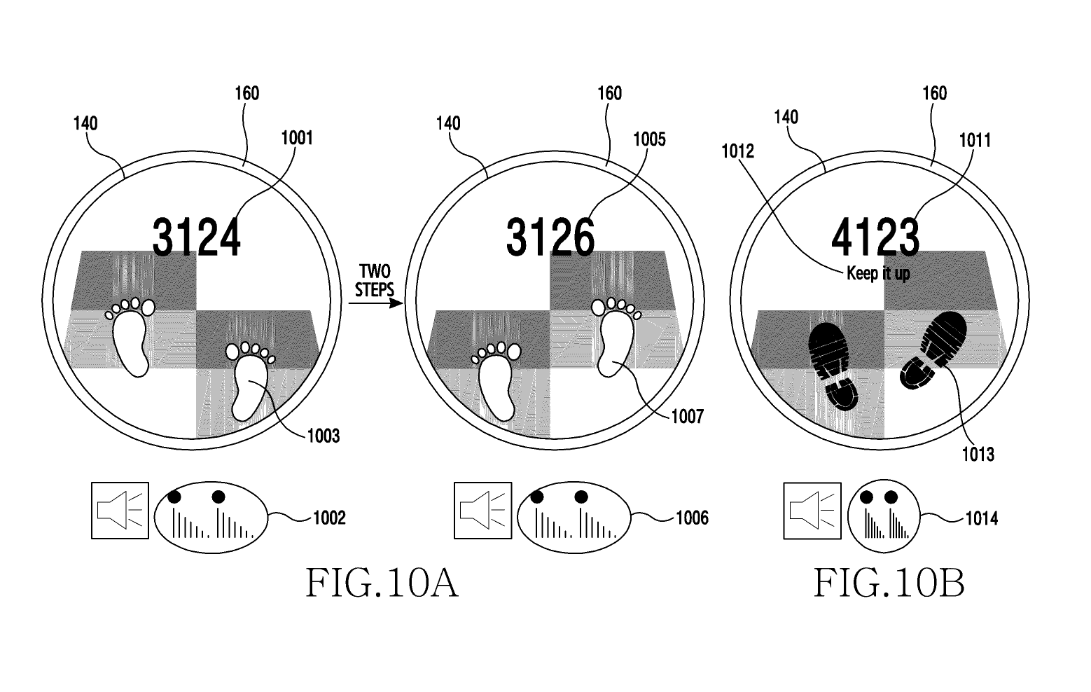

FIG. 10A is a screen shot illustrating the case of dynamic exercise, according to another embodiment of the present disclosure. FIG. 10B is a screen shot illustrating the case of dynamic exercise, according to another embodiment of the present disclosure. FIG. 11 is a screen shot illustrating the case of resting in the middle of dynamic exercise, according to another embodiment of the present disclosure.

Referring to FIGS. 7, 10A, 10B and 11, according to an embodiment of the present disclosure in which a user walks or runs, the control unit 190 may identify that the exercise guide for walking is a determined state, and the target exercise strength and the user profile information are set.

When the start menu 509 is selected in the state in which the target exercise strength is set as “Mild” as shown in FIG. 5, the control unit 190 may display, on the display unit 140, the motion number of the user sensed by the sensor unit 120, for example, a walking number 1001, as shown in FIG. 10A. The control unit 190 may alternately display, on the display unit 140, an image of a right sole and a left sole, based on the output period of the guide signal, and may output the guide signal in a vibration or a sound based on the output period as shown in a reference numeral 1002. The control unit 190 may output the guide signal every second. The control unit 190 may update 1005 and display the walking number whenever the motion is sensed, and may alternately display a left sole shape and a right sole shape displayed on the display unit 140 as shown in a reference numeral 1007 based on the output period of the guide signal.

When the start menu 509 is selected in the state in which the target exercise strength is set as “Hard”, as shown in FIG. 5, the control unit 190 may display, on the display unit 140, a screen as shown in FIG. 10B. The control unit 190 may display the number of motions of the user, for example, a walking number 1011, and may display a text 1012 for encouraging the user. The control unit 190 may alternately output, on the display unit 140, an image 1013 of a right shoe bottom and a left shoe bottom, based on the output period of the guide signal, and may output the guide signal in at least one of a vibration or a sound based on the output period as shown in reference numeral 1014. The control unit 190 may output the guide signal every 0.55 second.

The control unit 190 may calculate an average time for the motion number sensed during a predetermined time. The control unit 190 may update the output period based on the average time in the range of the set target exercise strength. For example, when the average time for the motion number sensed during the predetermined time in the state in which the target exercise strength is “Mild” state is 12 seconds per 10 steps, the control unit 190 may update the output period as 1.2 second. When the average time for the motion number that is sensed during the predetermined time is 4 seconds per 10 steps while in the state in which the target exercise strength is the “Hard” state, the control unit 190 may update the output period as 0.25 second.

The control unit 190 may provide the exercise guide using only the profile information without the target exercise strength of the user. The control unit 190 may regularly output the guide signal every average time stored in the memory 150 according to the generated exercise guide. There may be differences of time when a left sole and a right sole reach the ground, respectively, when people walk or run. Therefore, the user may alternately step on the ground with the left sole and the right sole, in accordance with the output period of the guide signal, and thus the user may equalize each of the time when the left sole reaches the ground and the time when the right sole reaches the ground. The control unit 190 may identify the average time for the motion number sensed during the predetermined time to update the output period.

When the motion is not sensed for the critical time in the middle of the walking, the control unit 190 may sense that the user is in the rest state. The control unit 190 may display, on the display unit 140, an image indicating the rest state as shown in FIG. 11. At this time, the control unit 190 may display a motion number 1101 before the rest state, and may display the image 1101 darker. The control unit 190 may gradually reduce the guide signal using the vibration or the sound, and may not output the guide signal to the user as shown in reference numeral 1103.

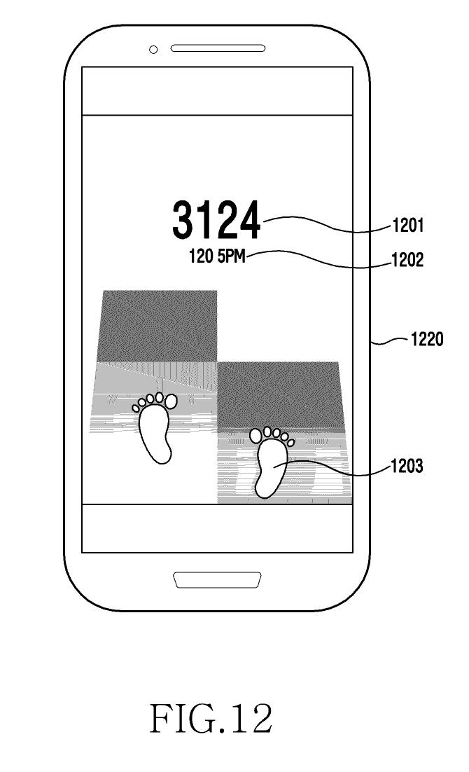

FIG. 12 is a screen shot illustrating the case of dynamic exercise in another device, according to another embodiment of the present disclosure. Referring to FIG. 12, according to the time when the user walks or runs, in the case wherein the electronic device 100 is a smart phone 1220, the control unit 190 may display, on a screen of the smart phone 1220, a screen as shown in FIG. 10A.

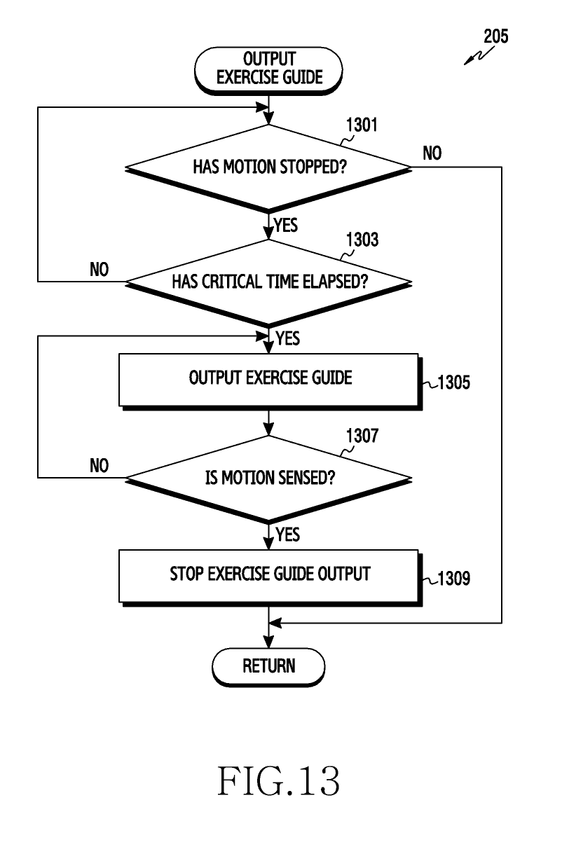

FIG. 13 is a flowchart describing a method of outputting the exercise guide, according to another embodiment of the present disclosure. FIG. 13 relates to a method of outputting the exercise guide for the static exercise.

Referring to FIG. 13, in step 1301, the control unit 190 checks whether the motion of the user is stopped. As a result of the check in step 1301, when the control unit 190 identifies that the motion of the user is stopped, the control unit 190 performs step 1303. As the result of the check of step 1301, when the motion of the user is not stopped, the control unit 190 returns to step 207 of FIG. 2.

In step 1303, when a critical time (e.g., two seconds) is elapsed after the motion is stopped, the control unit 190 performs step 1305. In step 1303, when the critical time is not elapsed after the motion is stopped, the control unit 190 returns to step 1301. In step 1305, the control unit 190 outputs the exercise guide. In step 1307, when the motion of the user is sensed again, the control unit 190 performs step 1309. In step 1309, the control unit 190 stops the output of the exercise guide, and returns to step 207 of FIG. 2. In step 1307, when the motion of the user is not sensed again, the control unit 190 returns to step 1305.

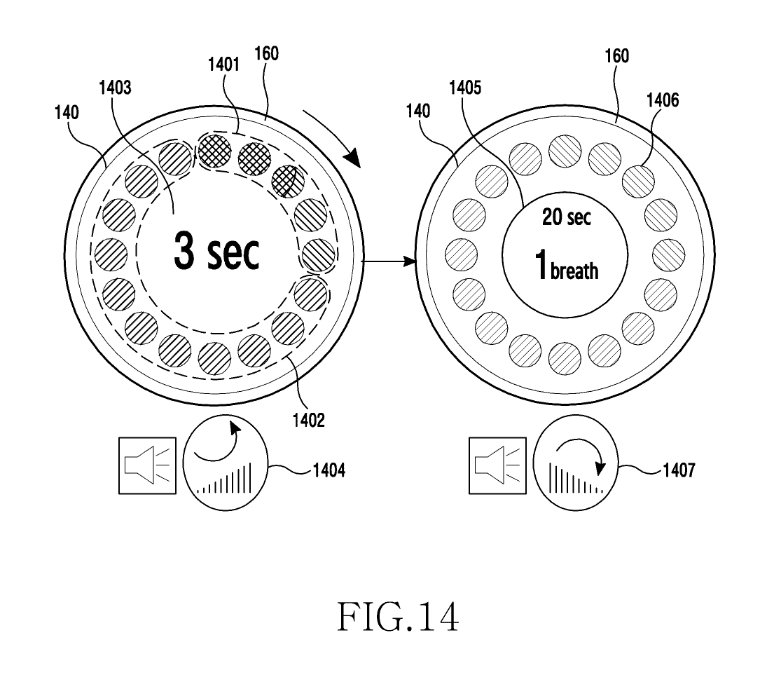

An operation for outputting the exercise guide is described in more detail with reference to FIG. 14.

FIG. 14 is a screen shot illustrating the case of static exercise, according to another embodiment of the present disclosure. Referring to FIG. 14, when Uddiyana breath is selected as shown in FIG. 6, the control unit 190 may display a screen for guiding a breath on the display unit 140.

The control unit 190 may output 1401 and 1402, on the edge of the display unit 140, the guide signal for guiding an inhalation and an exhalation, by differentiating the guide signal in a color. The control unit 190 may output time 1403 elapsed from the time when the exercise guide is displayed on the display unit 140. The control unit 190 may display an image darker for the guide signal that is output to the edge of the display unit 140 according to the elapsed time.

The control unit 190 may output at least one of a vibration and a sound by gradually increasing the strength of at least one of the vibration and the sound for 5 seconds when the user should inhale, as shown in a reference numeral 1404. The control unit 190 may output at least one of the vibration and the sound by gradually reducing the strength of at least one of the vibration and the sound for 15 seconds when the user should exhale, as shown in a reference numeral 1407. When 20 seconds has elapsed, which is a sum of 5 seconds of the inhalation and 15 seconds of the exhalation, the control unit 190 may display, on the display unit 140, the elapsed time of 20 seconds, and may display a completion of one breath. When 20 seconds has elapsed, the control unit 190 may darken the entire display unit 140, as shown in reference numeral 1406.

FIG. 15 is a screen shot illustrating an exercise result screen, according to an embodiment of the present disclosure.

Referring to FIG. 15, the control unit 190 displays a result of a completed exercise in step 213 of FIG. 2. The control unit 190 may display, on the display unit 140, a text which informs of an achievement of the exercise target, an exercise time, an exercise amount and a consumed calorie 1501. The control unit 190 may display RPM and BPM graph 1503 from an exercise start to an exercise end. The control unit 190 may calculate an average RPM 1505 from the exercise start to the exercise end. The control unit 190 may determine and display a maximum BPM 1507 from the exercise start to the exercise end.

When the electronic device 100 is connected to an external device 1520 including a smart phone in a wireless or wired communication, the electronic device 100 may display reference numeral 1501 on the display unit 140. In addition, the electronic device 100 may transmit reference numerals 1503, 1505 and 1507 to the external device 1520 such that the external device 1520 displays the reference numerals 1503, 1505 and 1507. The control unit 190 may sequentially display, on the display unit 140, the RPM and BPM graph 1503, the average RPM 1505 and the maximum BPM 1507, according to the rotation of the rotation unit 160.

FIG. 16 is a screen shot illustrating an exercise result screen, according to another embodiment of the present disclosure.

Referring to FIG. 16, the control unit 190 displays a result of an ended exercise in step 213 of FIG. 2. The control unit 190 may display, on the display unit 140, a text 1602 which informs of a completion of a walking exercise 1601, and may display a walking exercise time, a walked distance and a consumed calorie 1603. The control unit 190 may receive weather information 1604 of a date when the user has done the walking exercise, from an external device such as a server, to display the weather information 1604.

The control unit 190 may display RPM and BPM graph 1605 from an exercise start to an exercise end. The control unit 190 may calculate an average speed 1606 from the exercise start to the exercise end. The control unit 190 may check and display a maximum BPM 1607 from the exercise start to the exercise end. The control unit 190 may additionally display various pieces of information during the exercise, and the control unit 190 may display map data 1608 moved from the exercise start to the exercise end.

When the electronic device is connected to an external device 1620 including a smart phone in a wireless or wired communication, the electronic device 100 may display, on the display unit 140, only reference numerals 1601, 1602 and 1603. In addition, the electronic device 100 may transmit other pieces of information to the external device 1620 such that the external device 1620 displays other pieces of information. The control unit 190 may display, on the display unit 140, other pieces of information including the weather information 1604, the RPM and BPM graph 1605, the average speed 1606, the maximum RPM 1607, and the map data 1608 according to the rotation of the rotation unit 160.

According to an embodiment of the present disclosure, a method of operating an electronic device 100 configured to provide an exercise guide may include determining an output period, outputting a guide signal based on the output period, updating the output period of the guide signal based on a motion, and outputting the guide signal based on the updated output period. Outputting the guide signal may include outputting the guide signal in at least one of an image, a sound, and a vibration based on the output period.

Determining the output period may include setting a target exercise time and a target motion number, and determining the output period based on the target exercise time and the target motion number.

Updating the output period may include accumulating exercise data based on a motion number sensed during a predetermined time, and updating the output period based on a remaining time obtained by subtracting the predetermined time from the target exercise time, and a remaining motion number obtained by subtracting the sensed motion number from the target motion number.

Updating the output period may include sensing a motion number during a predetermined time, outputting a guide signal indicating a rest state when the motion is not sensed for a critical time, updating the target exercise time by adding the critical time to the target exercise time when the motion is sensed again, and updating the output period based on the updated target exercise time, and a remaining motion number obtained by subtracting the sensed motion number from the target motion number.

Determining the output period may include determining the output period according to a predetermined condition.

Updating the output period may include calculating an average time of the motion based on a motion number sensed during a predetermined time, and updating the output period using the average time.

Determining the output period may include setting target exercise strength, and determining the output period based on the target exercise strength.

Updating the output period may include calculating an average time based on a motion number sensed during a predetermined time, and updating the output period based on the average time in a time range set according to the target exercise strength.

Outputting the guide signal may include outputting the guide signal based on the output period when the motion is stopped.

Various embodiments of the present disclosure shown and described in the specification and the drawings correspond to specific examples presented in order to explain technical content of the present disclosure, and to help comprehension of the present disclosure, but do not limit the scope of the present disclosure.

While the present disclosure has been shown and described with reference to certain embodiments thereof, it will be understood by those skilled in the art that various changes in form and details may be made therein without departing from the spirit and scope of the present disclosure as defined by the appended claims and their equivalents.

What is claimed is:

1. A method of operating an electronic device configured to provide an exercise guide, the method comprising:
determining an output period;
outputting a guide signal based on the output period;
updating the output period of the guide signal based on a motion of a user; and
outputting the guide signal based on the updated output period.

2. The method of claim 1, wherein outputting the guide signal comprises outputting the guide signal in at least one of an image, a sound and a vibration based on the output period.

3. The method of claim 1, wherein determining the output period comprises:
setting a target exercise time and a target motion number; and
determining the output period based on the target exercise time and the target motion number.

4. The method of claim 3, wherein updating the output period comprises:
accumulating exercise data based on a motion number sensed during a predetermined time; and
updating the output period based on a remaining time obtained by subtracting the predetermined time from the target exercise time and a remaining motion number obtained by subtracting the sensed motion number from the target motion number.

5. The method of claim 3, wherein updating the output period comprises:
sensing a motion number during a predetermined time;
outputting a guide signal indicating a rest state, when the motion is not sensed for a critical time;
updating the target exercise time by adding the critical time to the target exercise time, when the motion is sensed again; and
updating the output period based on the updated target exercise time and a remaining motion number obtained by subtracting the sensed motion number from the target motion number.

6. The method of claim 1, wherein the output period is determined according to a predetermined condition.

7. The method of claim 6, wherein updating the output period comprises:
calculating an average time of the motion based on a motion number sensed during a predetermined time; and
updating the output period using the average time.

8. The method of claim 1, wherein determining the output period comprises:
setting a target exercise strength; and
determining the output period based on the target exercise strength.

9. The method of claim 8, wherein updating the output period comprises:
calculating an average time based on a motion number sensed during a predetermined time; and
updating the output period based on the average time in a time range set according to the target exercise strength.

10. The method of claim 1, wherein the guide signal is output based on the output period when the motion is stopped.

11. An electronic device for providing an exercise guide, comprising:
a display unit; and
a control unit configured to determine an output period, output a guide signal based on the output period, update the output period of the guide signal based on a motion of a user of the electronic device, output the guide signal based on the updated output period, and control the display unit configured to output the guide signal based on the output period.

12. The electronic device of claim 11, further comprising:
an alarm unit configured to output the guide signal as a vibration.

13. The electronic device of claim 11, wherein the control unit is further configured to set a target exercise time, set a target motion number, and determine the output period based on the target exercise time and the target motion number.

14. The electronic device of claim 13, wherein the control unit is further configured to:
accumulate exercise data based on a motion number sensed during a predetermined time, update the output period based on a remaining time obtained by subtracting the predetermined time from the target exercise time and a remaining motion number obtained by subtracting the sensed motion number from the target motion number.

15. The electronic device of claim 13, wherein the control unit is further configured to:
sense a motion number during a predetermined time,
output a guide signal indicating a rest state, when the motion is not sensed during a critical time,
update the target exercise time by adding the critical time to the target exercise time, when the motion is sensed again, update the output period based on the updated target exercise time and a remaining motion number obtained by subtracting the sensed motion number from the target motion number.

16. The electronic device of claim 11, wherein the control unit is further configured to determine the output period according to a predetermined condition.

17. The electronic device of claim 16, wherein the control unit is further configured to:
calculate an average time of the motion based on a motion number sensed during a predetermined time, and
update the output period using the average time.

18. The electronic device of claim 12, wherein the control unit is further configured to:
set target exercise strength, and
determine the output period based on the target exercise strength.

19. The electronic device of claim 18, wherein the control unit is further configured to:
calculate an average time of the motion based on a motion number sensed during a predetermined time, and
update the output period based on the average time in a time range set according to the target exercise strength.

20. The electronic device of claim 11, wherein the control unit is further configured to output the guide signal based on the output period when the motion is stopped.
